(19) United States
(12) Patent Application Publication
(10) Pub. No.: US 2016/0296770 A1
(43) Pub. Date: Oct. 13, 2016

(54) Safety harness with descender attachment aka Down E-Z

(71) Applicant: Mickey McArthur Kennedy, Medina, OH (US)

(72) Inventor: Mickey McArthur Kennedy, Medina, OH (US)

(21) Appl. No.: 14/545,224

(22) Filed: Apr. 10, 2015

(51) Int. Cl. A62B 1/14; A62B 35/00

(52) U.S. Cl. CPC A62B 1/14; A62B 35/0006

(57) ABSTRACT

An apparatus so designed, that when properly used, will aid in the prevention of an injury and or death from an accidental fall from an elevated position. This apparatus is designed so as to allow a fallen hunter, suspended from a safety harness, a safe and secure manner of descending to the ground. This harness design with twin vertical straps and duel hook up in conjunction with the wrap around leg straps relieves almost all femoral artery pressure. Simply push downward on the Prussic brake release and glide gently to earth.

### TECHNICAL FIELD

This present application relates to a safety harness mostly used by tree stand Hunters with a Descender attachment (DOWN E-Z) for a self controlled lowering of ones self to the ground in case of an accidental fall.

### BACKGROUND

Due to the awareness of tree stand safety, more hunters are turning to devices Which prevents falls from elevated positions which may cause bodily injury and even Death.

### BRIEF DESCRIPTIONS OF DRAWINGS

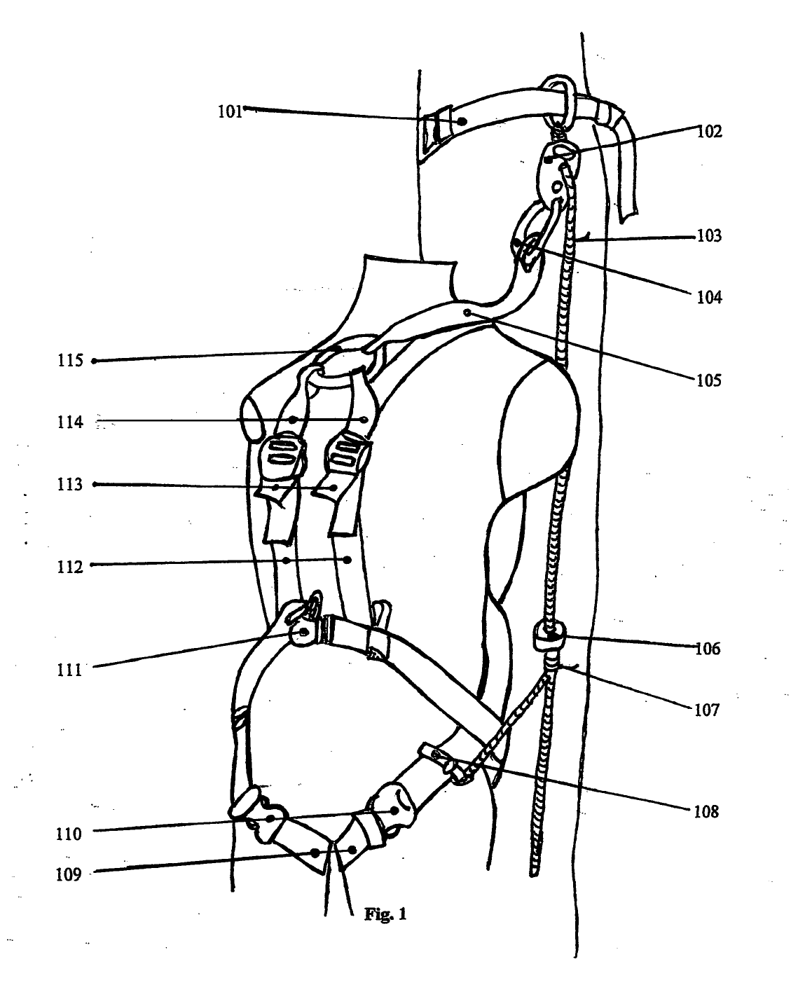

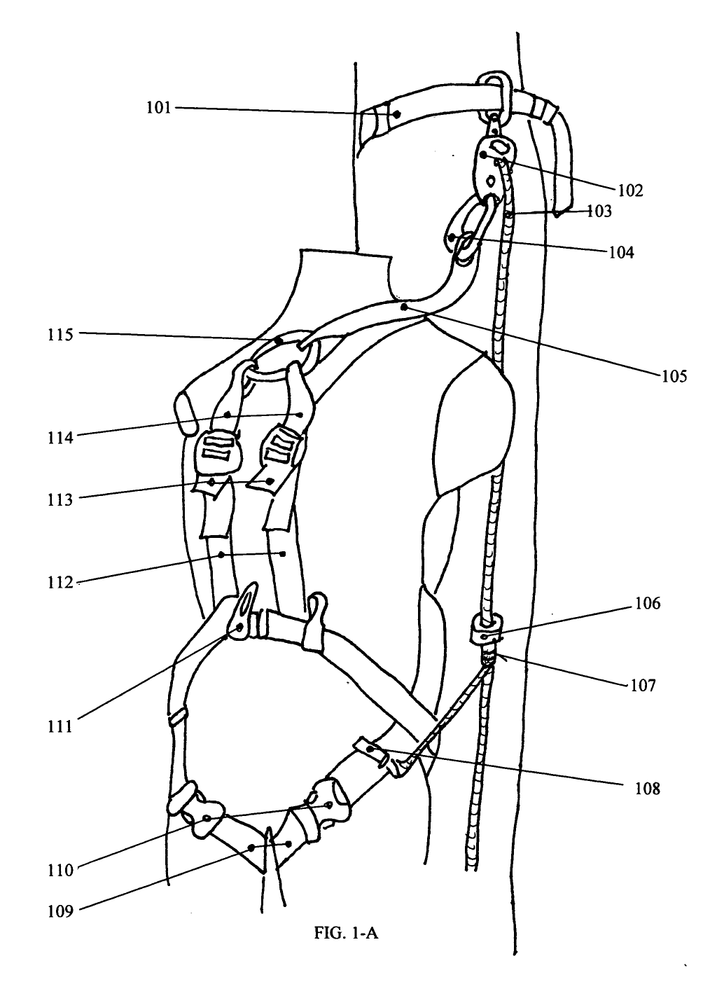

Pg. 1-9, FIG. 1 Drawing showing the assembled parts of harness and the DOWN E-Z system.

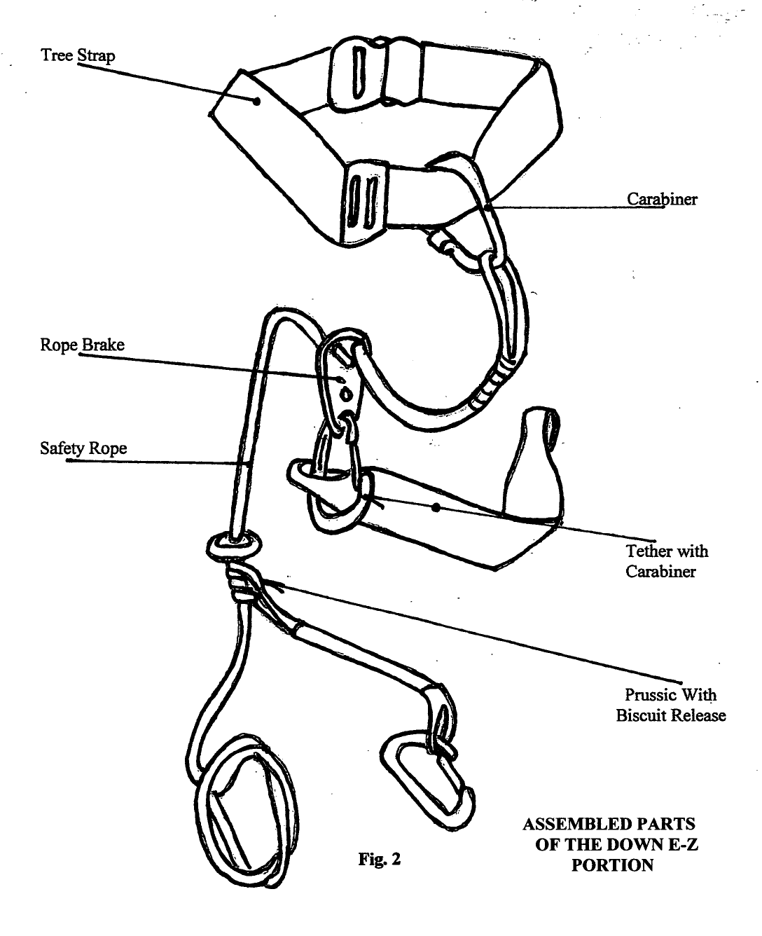

Pg. 2-9, FIG. 2 The assembled parts of the Down E-Z portion to include the Tree Strap, 3 carabiners, Tether, Safety rated rope, and the Prussic device used for exerting resistance to the rope brake.

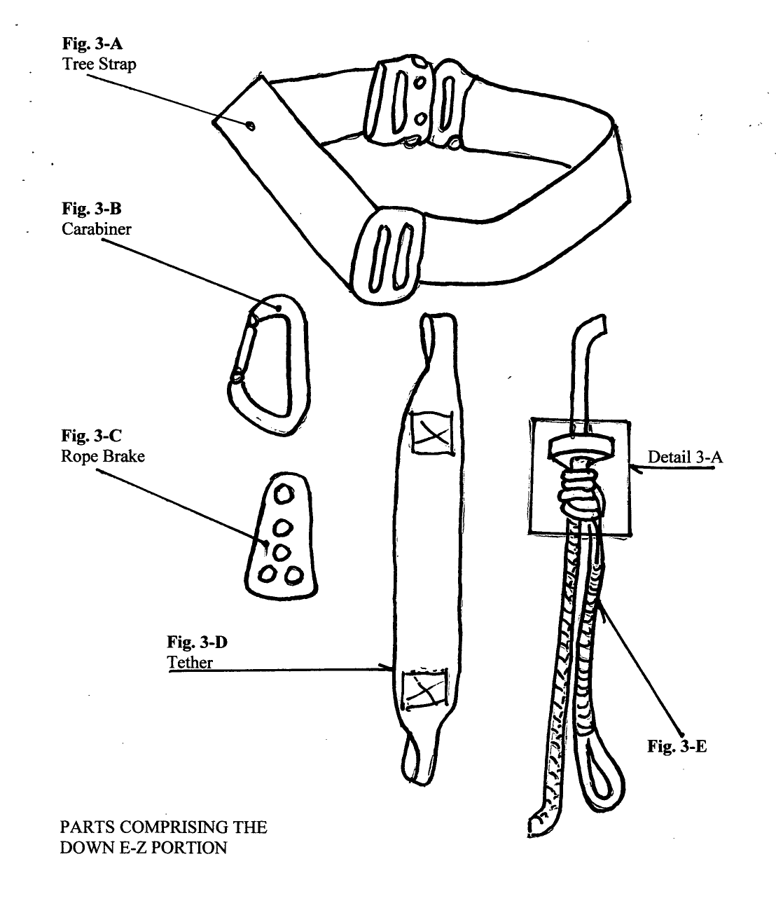

Pg. 3-9, FIG. 3-A The Tree Strap

Pg. 3-9, FIG. 3-B Purchased Carabiner

Pg. 3-9, FIG. 3-C The Rope Brake

Pg. 3-9, FIG. 3-D Safety rated Tether.

Pg. 3-9, FIG. 3-E Prussic Knot

Pg. 3-9, Detail 3-A, Showing Biscuit, Safety Rope and Prussic Knot.

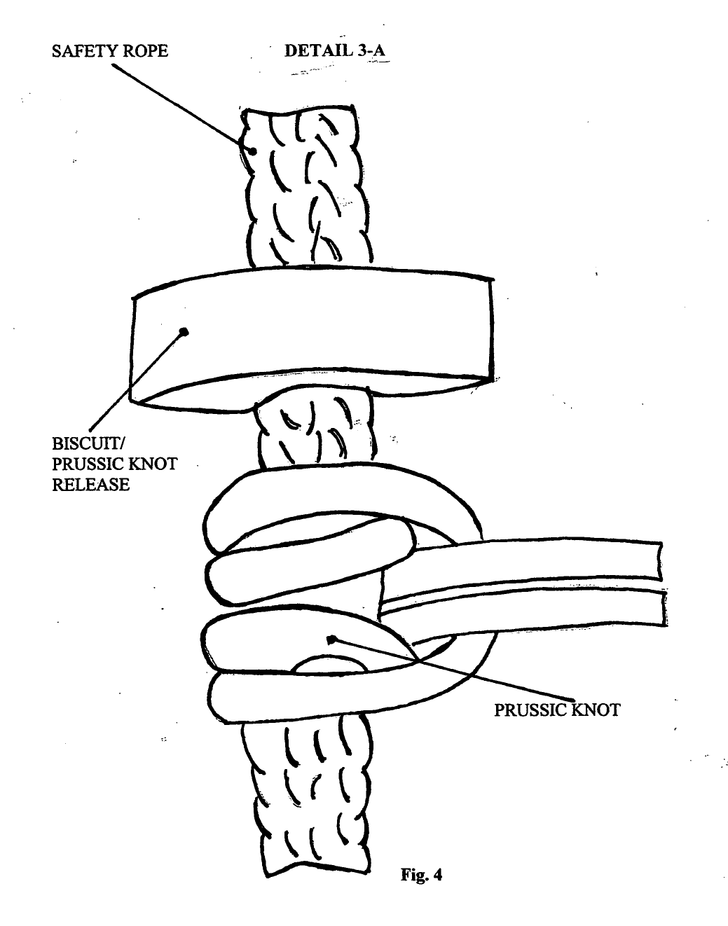

Pg. 4, FIG. 4 Exploded view showing Prussic Knot attachment to the Safety Rope.

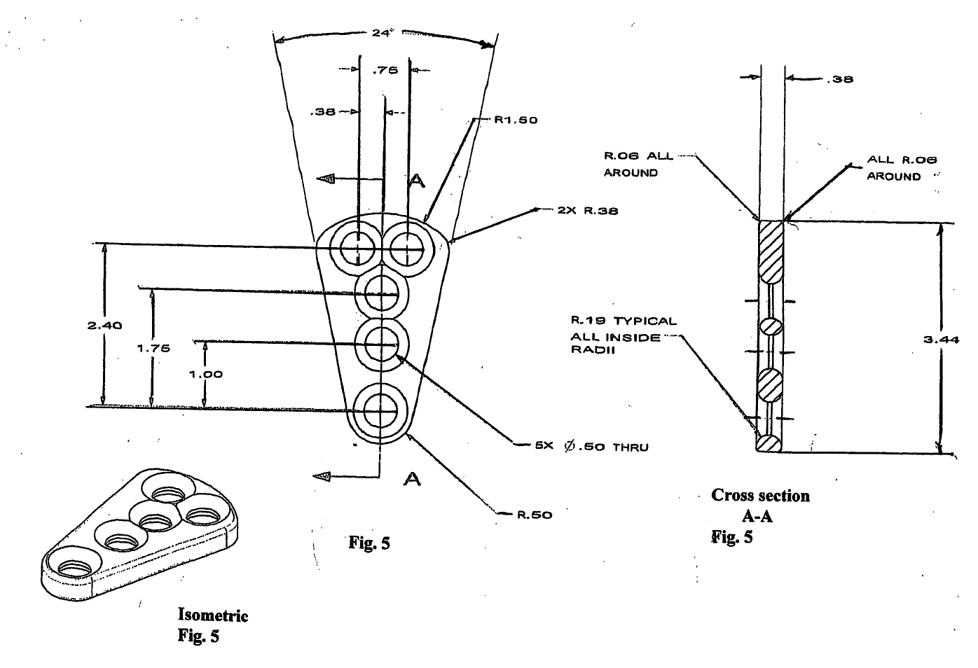

Pg. 5-9, FIG. 5 Cad drawing along with Isometric of FIG. 4 and Cross section of FIG. 4 showing detail of hole opening layout.

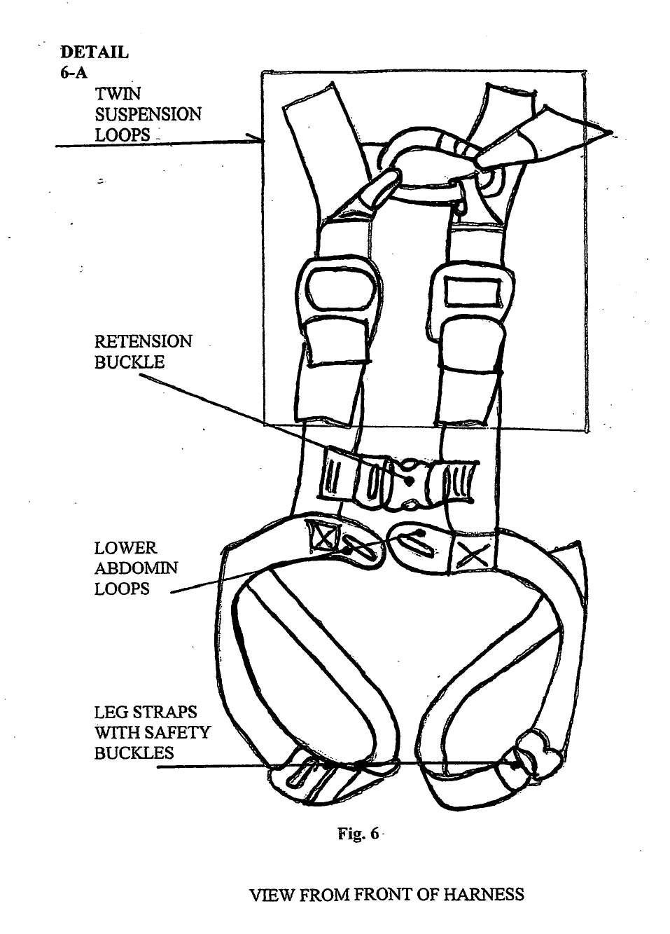

Pg. 6-9, FIG. 6 Is the frontal view of harness showing the upper chest and lower (abdomen) loops for Tether hook up. Also shown are the leg straps with safety rated quick disconnect buckles. Detail 6-A on following Pg. 7.

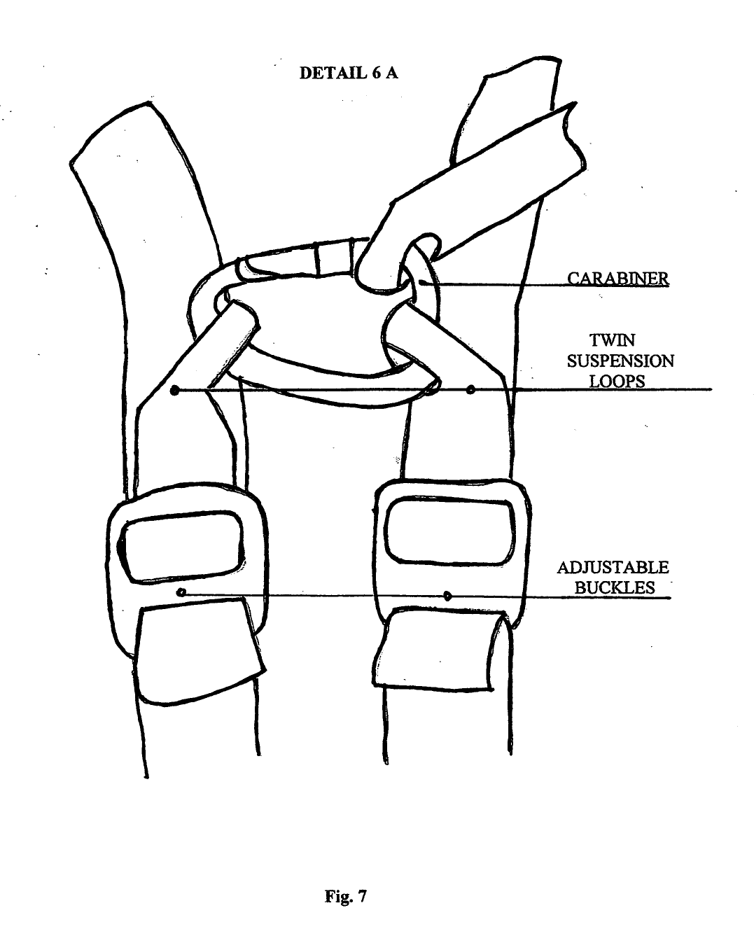

Pg. 7-9, FIG. 7 Is an exploded view of the twin chest suspension loops for Tether hook up with Carabiner. Also shown are two Acorn buckles for quick adjustment.

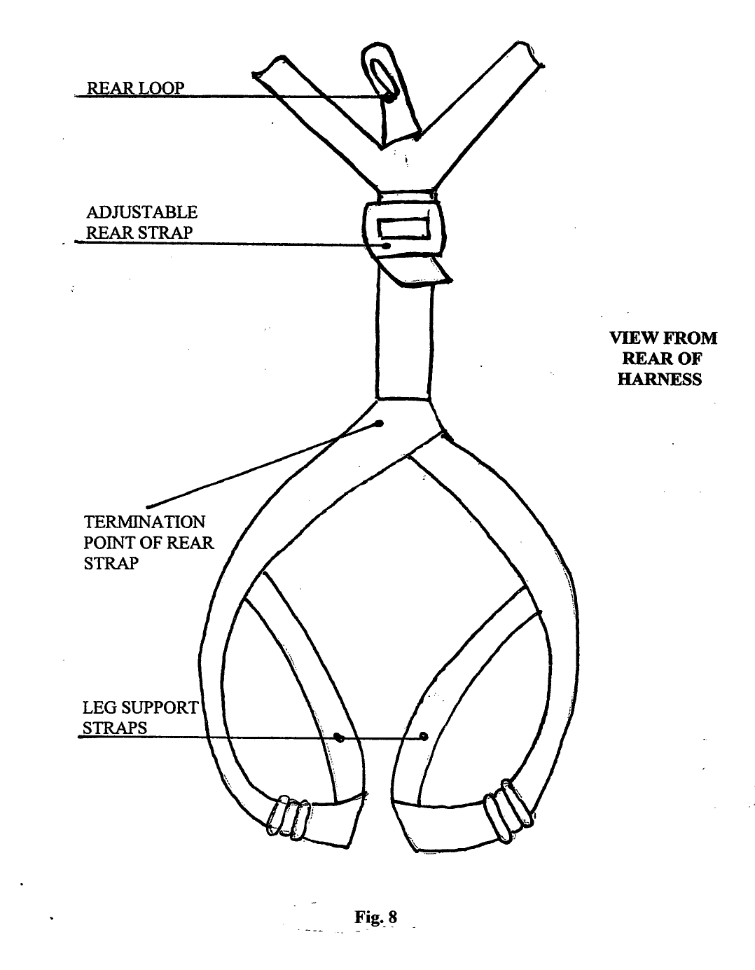

Pg. 8-9, FIG. 8 Is a view looking at the harness from the rear showing the vertical support strap and the junction of the leg straps. Small top loop is not intended for support of the hunter.

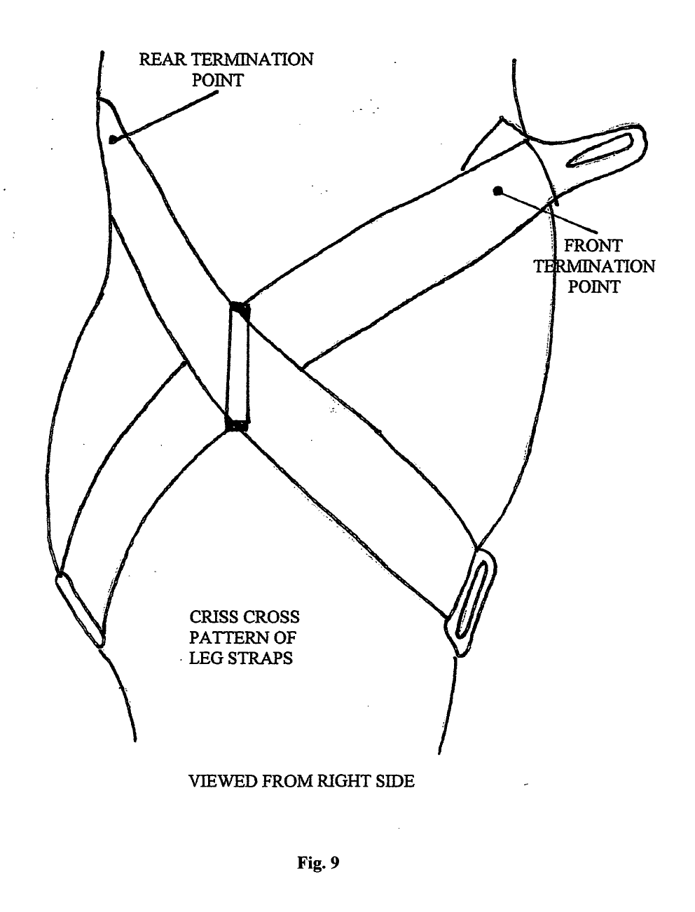

Pg. 9-9, FIG. 9 Is a side view of harness depicting the manner in which the leg strap encircles the hip and leg.

### Referring Back to PG. 1-9

Pg. 1-9 Items 101 thru 108 are those parts pertinent to the DOWN E-Z portion of this patent and are as follows.

101 The tree strap (can be substituted with safety rated rope) 102 Rope Brake 103 Safety rated rope 104 Safety rated carabiner 105 Tether 106 Brake release biscuit. 107 Prussic brake actuator 108 Safety buckle.

Items 109 thru 116 are those pertinent to the harness as follows. 109 Safety rated leg straps 110 Quick release safety rated leg strap buckles 111 Quick release retention buckle (safety rated) 112 Vertical support straps with 113 Quick adjust safety rated buckles 114 Twin support loops 115 Safety rated carabiner connecting Harness to 105 Tether.

### Overview

There are several safety harnesses on the market of which few have an attachment for lowering ones self to the ground safely. With this harness, in conjunction with the DOWN E-Z device, one can remain attached to the tree while ascending and or descending a tree. The descending device is so designed so as to allow the fallen hunter to descend a tree by merely releasing the prussic knot and in turn release the rope brake. Rope Brake slides down the rope until hunter reaches the ground safely.

### DETAILED DESCRIPTIONS

### These Descriptions Pertain to the Patent Application and Parts Thereof in Regards to the Invented Parts and or New Use of Purchased Parts.

Pg. 1-9 FIG. 1 Drawing of harness and Down E-Z depicting attachment to a tree and viewed from a 30 degree angle with details as follows. Quick release buckle 101 for fast and easy attachment to a tree used in conjunction with the strap carabiner 104 is used for connecting the tree strap to the double braid nylon rope 103 The rope brake 102 used in conjunction with the Prussic brake actuator 107 allows one to control descent by relieving the restrictive pressure to the safety rated rope 103 by applying downward pressure with the Prussic Biscuit 106. The safety rated Carabiner 104 is used to connect the Rope Brake 102 to the Tether 105 which in turn is connected to another safety rated Carabiner 115 which is there connected to the double chest loops 115. The biscuit 106 is used to release pressure from Prussic knot by applying downward pressure allowing the movement of the Rope Brake 102 along the safety rated rope. Safety Hook 108 used to attach the Prussic rope to the leg portion of the harness 109 which in turn applies restrictive pressure to the safety rope 103 Which in turn restricts movement of the Rope Brake 102. The leg straps 109 of this harness when connected thru the Quick Release Buckles 110 completely encircles the hips and legs providing a comfortable seat for suspension and lessens pressure on the Femoral Arteries. Vertical straps 112 which are connected to the Chest Buckles 113 are used for quick adjustment of the vertical strap tension.

Pg. 2-9 Drawing showing the associated parts of the DOWN E-Z portion to include.
Tree strap composed of a two part nylon safety rated strap with two buckles. Safety rated rope can also be used.
Safety rated Carabiner (purchased)
Rope brake (see cad drawing Pg. 5-9) mainstay of invention.
14 in. safety rated Tether with carabiner.
Prussic knot with Biscuit (brake actuator).

Pg. 3-9 FIG. 3-A The tree strap with two buckles, one to be adjustable and the other a quick release style buckle.

Pg. 3-9, FIG. 3-B Purchased Carabiner.

Pg. 3-9 FIG. 3-C Main stay to invention is this Rope Brake which provides tension on the rope when Prussic knot is actuated.

Pg. 3-9, FIG. 3-D Safety rated Tether for attaching the harness to the Safety rated rope.

Pg. 3-9, FIG. 3-E Detail 3-A The Prussic knot attached to the safety rope which provides the back pressure on Rope Brake providing the user control of his or her descent to the Ground.

Pg. 4-9, FIG. 4 Detail 3-A Is an exploded view of the attachment of the Prussic knot to the Safety Rope. This is the device which will apply resistance pressure downward on the Safety Rope preventing and accidental fall.

Pg. 5-9, FIG. 5 Depicts a drawing of the Rope Brake to include an Isometric and a Cross Section to show proper locations of associated holes which controls the descent of the fallen user when properly used in conjunction with the Prussic Brake actuator.

Pg. 6-9 FIG. 6 The frontal view of harness with detail to the leg straps revealing that when connected, the leg straps completely encircles the hips and legs providing total support without any pressure to the groin area. Also visible are the twin loop locations of the hook up points, which is detailed on Pg. 7 of the drawings.

Pg. 7-9, FIG. 7 Detail 6-A Is an exploded view of the hook up point with Carabiner looped thru the twin chest loops connected to each of the vertical straps. This manner of hook up provides a wider support range than a single support located in center of chest. Also shown are the two adjustable buckles for quick and easy adjustment.

Pg. 8-9 FIG. 8 Depiction of the rear view of harness. Most important, the location of the beginning of the leg straps which are joined in the mid line of back and completely encircles the hips and legs to a point, when buckled, to the middle of abdomen and there joins the frontal vertical straps.

Pg. 9-9 FIG. 9 A side view of the leg straps, particular attention is to be paid to the crisscross pattern of the straps and the complete encirclement of the hip area. This manner of support re-directs the pressure away from the Femoral arteries.

What is claimed:

1. An apparatus comprising:
A rope brake configured to halt descent of a mass affixed to a harness, and to enable descent of the mass in response to variations in tension of a compatible rope that traverses the rope brake, the rope brake comprising:
Rope brake frame with a set of holes, wherein a hole from the set of holes has a diameter that is a function of a diameter of the compatible rope that is compatible with the rope brake.

2. The apparatus of claim 1, further comprising the harness attached to the rope brake.

3. The apparatus of claim 2, wherein the harness is configured to support a human, comprising leg support straps, lower abdomen straps with lower abdomen loops, a retention buckle, and vertical support straps with twin suspension loops.

4. The apparatus of claim 3, further comprising a carabiner that latches thru the twin suspension loops and a loop for the tether that connects the harness to the rope brake.

5. The apparatus of claim 1, further comprising the compatible rope, wherein a first portion of the compatible rope is woven through at least a subset of the set of holes.

6. The apparatus of claim 5, further comprising a second rope attached to a second portion of the compatible rope via a Prussic knot and attached to the harness by an attachment means.

7. The apparatus of claim 6, wherein the Prussic knot is configured to create the variations in the tension of the compatible rope in response to a force applied to the Prussic knot in a direction away from the rope brake.

8. The apparatus of claim 7, further comprising the biscuit attached to the second portion of the compatible rope proximal to the Prussic knot.

9. The apparatus of claim 8, wherein a biscuit is configured to create the variations in tension of the compatible rope in response to a downward force applied to the biscuit in a direction away from the Rope Brake.
